(19) United States
(12) Patent Application Publication
(10) Pub. No.: US 2026/0037320 A1
(43) Pub. Date: Feb. 5, 2026

(54) SYSTEM AND METHOD FOR DYNAMIC DISTRIBUTED MODEL LOADING

(71) Applicant: Walmart Apollo, LLC, Bentonville, AR (US)

(72) Inventors: Malay Kumar Patel, Fremont, CA (US); Manimuthu Ayyannan, Fremont, CA (US); Thilak Raj Balasubramanian, San Jose, CA (US); Sushant Kumar, San Jose, CA (US); Kannan Achan, Saratoga, CA (US)

(21) Appl. No.: 18/792,100

(22) Filed: Aug. 1, 2024

(51) Int. Cl. G06F 9/50

(52) U.S. Cl. CPC G06F 9/5038; G06F 9/5055; G06F 2209/5011; G06F 2209/503

(57) ABSTRACT

System and methods for dynamic distributed model loading are disclosed. In some embodiments, a disclosed method includes: storing, in a database, historical data associated with previously loaded models, receiving a model loading request associated with a first model via a user interface, identifying one or more model parameters associated with the first model, generating a score value associated with the first model based on the one or more model parameters, based on the score value, partitioning the first model into a plurality of first model segments, ranking the plurality of first model segments with a plurality of second model segments associated with a second model, and executing each of the plurality of first model segments and the plurality of second model segments based on the ranking.

### TECHNICAL FIELD

This application relates generally to dynamic distributed model loading and, more particularly, to systems and methods for dynamic priority driven distributed model loading.

### BACKGROUND

Many software packages and applications utilize continuous model loading to implement changes. Efficient and frequent loading of models is important to machine learning workflows. Some workflows require that models be loaded hourly, daily, and/or weekly based on needs. Further, model loading is crucial for improving the freshness of model data and enhancing customer understanding. Outdated models due to slow loading processes can lead to suboptimal personalization and customer experiences, impacting outcomes and customer satisfaction.

Model loading applications that integrate with various big data technologies, data sources, sinks, and processors can be complex. The challenge lies in seamlessly integrating these components to ensure efficient and effective loading of models. Additionally, the presence of multiple loading applications in a cluster makes it difficult to estimate resources and run times accurately, resulting in inefficiencies and delays in the model loading process. Moreover, the competing priorities of high and low priority model loading applications introduce latency to the inference layers. This latency can impact the real-time performance and responsiveness of the system, affecting the quality of personalization and customer experiences.

### SUMMARY

The embodiments described herein are directed to systems and methods for dynamic distributed model loading.

In various embodiments, a system including a database storing historical data associated with previously loaded models and a computing device comprising at least one processor in communication with the database. The computing device is configured to receive a model loading request associated with a first model via a user interface, identify one or more model parameters associated with the first model, generate a score value associated with the first model based on the one or more model parameters, based on the score value, partition the first model into a plurality of first model segments, rank the plurality of first model segments with a plurality of second model segments associated with a second model, and execute each of the plurality of first model segments and the plurality of second model segments based on the ranking.

In some embodiments, the computing device is further configured to generate a status log based on the execution of the plurality of first model segments. The computing device is further configured to parse the status log to identify resource allocation data and using the resource allocation data, refine the execution of a subsequent model.

In some embodiments, the computing device is further configured to compare the score value to predetermined threshold, and if the score value is above the predetermined threshold, partition the first model into the plurality of first model segments.

In some embodiments, the computing device is further configured to execute at least a subset of the plurality of first model segments in a parallel.

In some embodiments, each first model segment of the plurality of first model segments has a file size less than a file size of the first model.

In some embodiments, the ranking is based on a prioritization of the plurality of first model segments based on the one or more of the one or more model parameters and the historical data.

In some embodiments, the computing device is further configured to generate the score value using one or more machine learning algorithms, and refine the one or more machine learning algorithms based on one or more of the historical data and the execution of the plurality of first model segments.

In some embodiments, one or more model parameters including one or more of file size, source, target, run time, creation date, and contents.

In some embodiments, the computing device is further configured to aggregate the plurality of first model segments with the plurality of second model segments to generate an execution pool, receive a third model segment for execution, the third model segment having a higher priority than each of the plurality of first model segments and each of the plurality of second model segments, rank the third model segment higher than each of the plurality of first model segments and each of the plurality of second model segment, and execute the third model segment prior to each of the plurality of first model segments and each of the plurality of second model segments.

In various embodiments, a computer-implemented method is disclosed. The computer-implemented method includes storing, in a database, historical data associated with previously loaded models, receiving a model loading request associated with a first model via a user interface, identifying one or more model parameters associated with the first model, generating a score value associated with the first model based on the one or more model parameters, based on the score value, partitioning the first model into a plurality of first model segments, ranking the plurality of first model segments with a plurality of second model segments associated with a second model, and executing each of the plurality of first model segments and the plurality of second model segments based on the ranking.

In some embodiments, the method includes generating a status log based on the execution of the plurality of first model segments. The method further includes parsing the status log to identify resource allocation data, and using the resource allocation data, refine the execution of a subsequent model.

In some embodiments, the method includes comparing the score value to predetermined threshold, and if the score value is above the predetermined threshold, partition the first model into the plurality of first model segments.

In some embodiments, the method includes executing at least a subset of the plurality of first model segments in a parallel.

In some embodiments, each first model segment of the plurality of first model segments has a file size less than a file size of the first model.

In some embodiments, the ranking is based on a prioritization of the plurality of first model segments based on the one or more of the one or more model parameters and the historical data.

In some embodiments, the method includes generating the score value using one or more machine learning algorithms, and refining the one or more machine learning algorithms based on one or more of the historical data and the execution of the plurality of first model segments.

In some embodiments, the method includes aggregating the plurality of first model segments with the plurality of second model segments to generate an execution pool, receiving a third model segment for execution, the third model segment having a higher priority than each of the plurality of first model segments and each of the plurality of second model segments, ranking the third model segment higher than each of the plurality of first model segments and each of the plurality of second model segment, and executing the third model segment prior to each of the plurality of first model segments and each of the plurality of second model segments.

In various embodiments, a non-transitory computer readable medium having instructions stored thereon is disclosed. The instructions, when executed by at least one processor, cause at least one device to perform operations including: storing, in a database, historical data associated with previously loaded models, receiving a model loading request associated with a first model via a user interface, identifying one or more model parameters associated with the first model, generating a score value associated with the first model based on the one or more model parameters, based on the score value, partitioning the first model into a plurality of first model segments, ranking the plurality of first model segments with a plurality of second model segments associated with a second model, and executing each of the plurality of first model segments and the plurality of second model segments based on the ranking.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 is a network environment configured for dynamic distributed model loading, in accordance with some embodiments of the present teaching.

FIG. 2 is a block diagram of model loading engine, in accordance with some embodiments of the present teaching.

FIG. 3 is a flow diagram of a system for dynamic distributed model loading, in accordance with some embodiments of the present teaching.

FIG. 4 is a flow diagram of an exemplary model for dynamic distributed model loading, in accordance with some embodiments of the present teaching.

FIG. 5 is a system architecture for dynamic distributed model loading, in accordance with some embodiments of the present teaching.

FIG. 6 is an illustration showing resource allocation and utilization for a system for dynamic distributed model loading, in accordance with some embodiments of the present teaching.

FIG. 7 is an illustration of aggregating segments for a system for dynamic distributed model loading, in accordance with some embodiments of the present teaching.

FIG. 8 is an illustration of partitioning models for a system for dynamic distributed model loading, in accordance with some embodiments of the present teaching.

FIG. 9 is a flow diagram of an exemplary model for dynamic distributed model loading using the model loading engine of FIG. 2, in accordance with some embodiments of the present teaching.

### DETAILED DESCRIPTION

This description of the exemplary embodiments is intended to be read in connection with the accompanying drawings, which are to be considered part of the entire written description. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages or alternative embodiments herein can be assigned to the other claimed objects and vice versa. In other words, claims for the systems can be improved with features described or claimed in the context of the methods. In this case, the functional features of the method are embodied by objective units of the systems.

The present disclosure provides systems and methods for dynamic distributed model loading. In some embodiments, the systems and methods utilize models (e.g., machine learning models) to identify which models have higher priority. For example, the systems and method provided herein may identify models that are more critical to the functioning of an application or software package and may prioritize that model ahead of other models in a queue.

In some embodiments, the system and methods for dynamic distributed model loading utilizes tenant agnostic features that optimize the model loading process. By capturing model source parameters and generating a relative score for optimization, the system and methods disclosed herein can perform distributed loading of model data. This optimization improves the efficiency and frequency of model loading, reducing the time required from weeks to days or even hours and the introduction of a priority-driven schedule pool allows for intelligent execution of model loading based on business criticality. This ensures that high priority applications are given precedence, minimizing latency in the inference layers and improving overall system performance.

The proposed invention aims to solve the problem of efficient and frequent model loading in Personalization ML workflows. By addressing the business and technical challenges, it enhances the freshness of model data, improves resource utilization, and reduces latency, leading to better personalization and customer experiences.

In some embodiments, the systems and methods provided herein utilize one or more machine models to identify the likelihood that a high priority model will need to be loaded. Based on the identification of a high priority model, the systems and methods provided herein may prioritize the high priority model and then switch back to loading the segments of other models.

In some embodiments, the systems and methods provided herein breakdown the model to be loaded into smaller segments. This results in the overall loading of the model requiring less resources (e.g., computer resources). In some embodiments, the individual segments comprising the model may be loaded in parallel to reduce the overall load time of the model.

In some embodiments, the systems and methods provided herein are configured to generate a score for each model to be loaded (e.g., planned model). The score may indicate whether there is a need for distributed loading of the planned model. The score may also indicate the number of segments that the planned model is broken into for loading.

Furthermore, in the following, various embodiments are described with respect to methods and systems for dynamic distributed model loading. In some embodiments, a disclosed method includes: storing, in a database, historical data associated with previously loaded models, receiving a model loading request associated with a first model via a user interface, identifying one or more model parameters associated with the first model, generating a score value associated with the first model based on the one or more model parameters, based on the score value, partitioning the first model into a plurality of first model segments, ranking the plurality of first model segments with a plurality of second model segments associated with a second model, and executing each of the plurality of first model segments and the plurality of second model segments based on the ranking.

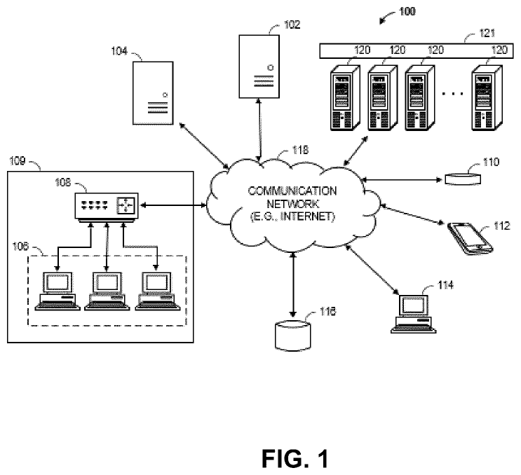

Turning to the drawings, FIG. 1 is a network environment 100 configured for dynamic distributed model loading, in accordance with some embodiments of the present teaching. The network environment 100 includes a plurality of devices or systems configured to communicate over one or more network channels, illustrated as a network cloud 118. For example, in various embodiments, the network environment 100 can include, but not limited to, model loading engine (“MLE”) 102 (e.g., a server, such as an application server), a web server 104, a cloud-based engine 121 including one or more processing devices 120, workstation(s) 106, a database 116, and one or more user computing devices 110, 112, 114 operatively coupled over the network 118. The MLE 102, the web server 104, the workstation(s) 106, the processing device(s) 120, and the multiple user computing devices 110, 112, 114 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit and receive data over the communication network 118.

In some examples, each of the MLE 102 and the processing device(s) 120 can be a computer, a workstation, a laptop, a server such as a cloud-based server, or any other suitable device. In some examples, each of the processing devices 120 is a server that includes one or more processing units, such as one or more graphical processing units (GPUs), one or more central processing units (CPUs), and/or one or more processing cores. Each processing device 120 may, in some examples, execute one or more virtual machines. In some examples, processing resources (e.g., capabilities) of the one or more processing devices 120 are offered as a cloud-based service (e.g., cloud computing). For example, the cloud-based engine 121 may offer computing and storage resources of the one or more processing devices 120 to the MLE 102.

In some examples, each of the multiple user computing devices 110, 112, 114 can be a cellular phone, a smart phone, a tablet, a personal assistant device, a voice assistant device, a digital assistant, a laptop, a computer, or any other suitable device. In some examples, the web server 104 hosts one or more applications configured to load models.

The workstation(s) 106 are operably coupled to the communication network 118 via a router (or switch) 108. The workstation(s) 106 and/or the router 108 may be located at a store 109 of a retailer, for example. The workstation(s) 106 can communicate with the MLE 102 over the communication network 118. The workstation(s) 106 may send data to, and receive data from, the MLE 102.

Although FIG. 1 illustrates three user computing devices 110, 112, 114, the network environment 100 can include any number of user computing devices 110, 112, 114. Similarly, the network environment 100 can include any number of the MLE 102, the processing devices 120, the workstations 106, the web servers 104, and the databases 116.

The communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. The communication network 118 can provide access to, for example, the Internet.

In some embodiments, each of the first user computing device 110, the second user computing device 112, and the Nth user computing device 114 may communicate with the web server 104 over the communication network 118. For example, each of the multiple computing devices 110, 112, 114 may be operable to view, access, and interact with a website or application hosted by the web server 104. The web server 104 may transmit user session data related to a user's activity (e.g., interactions) on the website or application.

In some examples, a customer may operate one of the user computing devices 110, 112, 114 to initiate a web browser or application that is directed to a website or application hosted by the web server 104. The customer may, via the web browser, view a user interface for viewing and interacting one or more applications. The one or more applications may allow a user to view, interact with, and/or load one or more models. In some embodiments, the applications capture these activities as user session data, and transmit the user session data to the MLE 102 over the communication network 118.

In some embodiments, the web server 104 transmits a request to the MLE 102, e.g. based on a user's request for loading a model. For example, the request may be sent based on a user providing an input into an application. The request may be sent standalone or together with other related data of the application (e.g., a website). In some examples, the request may carry or indicate user data.

In some examples, the MLE 102 may execute one or more models (e.g., algorithms), such as a mathematical models, machine learning model, deep learning model, statistical model, etc., to provide an output to the user. The output may be presented on the user interface and/or may include an optimization and prioritization plans for loading a model.

The MLE 102 is further operable to communicate with the database 116 over the communication network 118. For example, the MLE 102 can store data to, and read data from, the database 116. The database 116 can be a remote storage device, such as a cloud-based server, a disk (e.g., a hard disk), a memory device on another application server, a networked computer, or any other suitable remote storage. Although shown remote to the MLE 102, in some examples, the database 116 can be a local storage device, such as a hard drive, a non-volatile memory, or a USB stick. The MLE 102 may store historical data, business metrics, user data, or data associated with one or more models. Database 116 may be coupled to a computing device. For example, database 116 may be coupled to one or more user computing devices 110, 112, 114 via communication network 118.

In some embodiments, the web server 104 transmits a machine model training request to the MLE 102. Upon the machine model training request, the MLE 102 may retrieve, e.g. from the database 116, historical data associated with previous loading of models. The MLE 102 may train one or more machine models using the historical data. The one or more machine models may be trained to generate outputs for MLE 102. The one or more machine models may be trained to generate outputs for MLE 102 based on a request from a user. In some embodiments, the one or more machine models are configured to receive feedback from the user to refine or retrain the one or more machine models. For example, a user may transmit a request to MLE 102. MLE 102 may provide an optimization and prioritization plan for loading a model and implement the plan to load the model. The user may transmit a subsequent request to MLE 102 including adjustments to the plans for loading the model. MLE 102 may provide updated or refined optimization and prioritization plan for loading a model and implement the updated and refined plan to load the model.

In some embodiments, the outputs from the machine model may be used to refine and train the machine model. For example, one or more machine models may be trained using historical data. MLE 102 may receive adjustment or refinement data associated with whether the user made or requested additional adjustments or refinements to the generated outputs. The adjustment data may be inputted into the one or more machine models such that the one or more machine models compares the adjustments to the generated outputs to generate a comparison value. The greater the comparison value the greater the deviation the adjustment is from the generated plan. In other words, the greater the comparison value, the less accurate the one or more machine models are. In some embodiments, the comparison value may be inputted into the one or more machine models to refine the one or more machine models to make the one or more machine models more accurate.

In some examples, the MLE 102 assigns the machine models (or parts thereof) for execution to one or more processing devices 120. For example, each machine model may be assigned to a virtual machine hosted by a processing device 120. The virtual machine may cause the machine models or parts thereof to execute on one or more processing units such as GPUs. In some examples, the virtual machines assign each machine model (or part thereof) among a plurality of processing units.

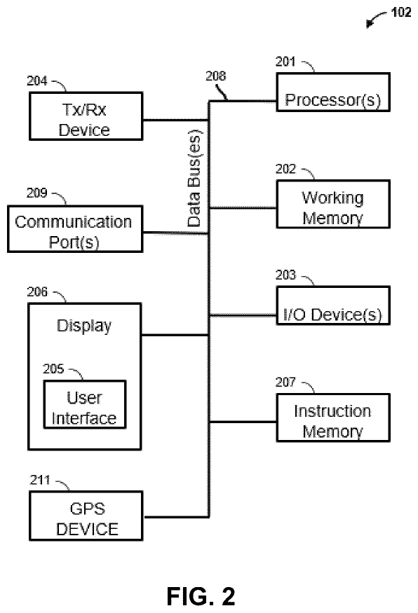

FIG. 2 illustrates a block diagram of MLE 102 of FIG. 1, in accordance with some embodiments of the present teaching. In some embodiments, each of the MLE 102, the web server 104, the multiple user computing devices 110, 112, 114, and the one or more processing devices 120 in FIG. 1 may include the features shown in FIG. 2. Although FIG. 2 is described with respect to certain components shown therein, it will be appreciated that the elements of the MLE 102 can be combined, omitted, and/or replicated. In addition, it will be appreciated that additional elements other than those illustrated in FIG. 2 can be added to the MLE 102.

As shown in FIG. 2, the MLE 102 can include one or more processors 201, an instruction memory 207, a working memory 202, one or more input/output devices 203, one or more communication ports 209, a transceiver 204, a display 206 with a user interface 205, and an optional location device 211, all operatively coupled to one or more data buses 208. The data buses 208 allow for communication among the various components. The data buses 208 can include wired, or wireless, communication channels.

The one or more processors 201 can include any processing circuitry operable to control operations of the MLE 102. In some embodiments, the one or more processors 201 include one or more distinct processors, each having one or more cores (e.g., processing circuits). Each of the distinct processors can have the same or different structure. The one or more processors 201 can include one or more central processing units (CPUs), one or more graphics processing units (GPUs), application specific integrated circuits (ASICs), digital signal processors (DSPs), a chip multiprocessor (CMP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The one or more processors 201 may also be implemented by a controller, a microcontroller, an application specific integrated circuit (ASIC), a field programmable gate array (FPGA), a programmable logic device (PLD), etc.

In some embodiments, the one or more processors 201 are configured to implement an operating system (OS) and/or various applications. Examples of an OS include, for example, operating systems generally known under various trade names such as Apple macOS™, Microsoft Windows™, Android™, Linux™, and/or any other proprietary or open-source OS. Examples of applications include, for example, network applications, local applications, data input/output applications, user interaction applications, etc.

The instruction memory 207 can store instructions that can be accessed (e.g., read) and executed by at least one of the one or more processors 201. For example, the instruction memory 207 can be a non-transitory, computer-readable storage medium such as a read-only memory (ROM), an electrically erasable programmable read-only memory (EEPROM), flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. The one or more processors 201 can be configured to perform a certain function or operation by executing code, stored on the instruction memory 207, embodying the function or operation. For example, the one or more processors 201 can be configured to execute code stored in the instruction memory 207 to perform one or more of any function, method, or operation disclosed herein.

Additionally, the one or more processors 201 can store data to, and read data from, the working memory 202. For example, the one or more processors 201 can store a working set of instructions to the working memory 202, such as instructions loaded from the instruction memory 207. The one or more processors 201 can also use the working memory 202 to store dynamic data created during one or more operations. The working memory 202 can include, for example, random access memory (RAM) such as a static random access memory (SRAM) or dynamic random access memory (DRAM), Double-Data-Rate DRAM (DDR-RAM), synchronous DRAM (SDRAM), an EEPROM, flash memory (e.g. NOR and/or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, a removable disk, CD-ROM, any non-volatile memory, or any other suitable memory. Although embodiments are illustrated herein including separate instruction memory 207 and working memory 202, it will be appreciated that the MLE 102 can include a single memory unit configured to operate as both instruction memory and working memory. Further, although embodiments are discussed herein including non-volatile memory, it will be appreciated that computing device 110, 112, 114 can include volatile memory components in addition to at least one non-volatile memory component.

In some embodiments, the instruction memory 207 and/or the working memory 202 includes an instruction set, in the form of a file for executing various methods, e.g. any method as described herein. The instruction set can be stored in any acceptable form of machine-readable instructions, including source code or various appropriate programming languages. Some examples of programming languages that can be used to store the instruction set include, but are not limited to: Java, JavaScript, C, C++, C#, Python, Objective-C, Visual Basic, .NET, HTML, CSS, SQL,
NoSQL, Rust, Perl, etc. In some embodiments a compiler or interpreter is configured to convert the instruction set into machine executable code for execution by the one or more processors 201.

The input-output devices 203 can include any suitable device that allows for data input or output. For example, the input-output devices 203 can include one or more of a keyboard, a touchpad, a mouse, a stylus, a touchscreen, a physical button, a speaker, a microphone, a keypad, a click wheel, a motion sensor, a camera, and/or any other suitable input or output device.

The transceiver 204 and/or the communication port(s) 209 allow for communication with a network, such as the communication network 118 of FIG. 1. For example, if the communication network 118 of FIG. 1 is a cellular network, the transceiver 204 is configured to allow communications with the cellular network. In some embodiments, the transceiver 204 is selected based on the type of the communication network 118 the MLE 102 will be operating in. The one or more processors 201 are operable to receive data from, or send data to, a network, such as the communication network 118 of FIG. 1, via the transceiver 204.

The communication port(s) 209 may include any suitable hardware, software, and/or combination of hardware and software that is capable of coupling the MLE 102 to one or more networks and/or additional devices. The communication port(s) 209 can be arranged to operate with any suitable technique for controlling information signals using a desired set of communications protocols, services, or operating procedures. The communication port(s) 209 can include the appropriate physical connectors to connect with a corresponding communications medium, whether wired or wireless, for example, a serial port such as a universal asynchronous receiver/transmitter (UART) connection, a Universal Serial Bus (USB) connection, or any other suitable communication port or connection. In some embodiments, the communication port(s) 209 allows for the programming of executable instructions in the instruction memory 207. In some embodiments, the communication port(s) 209 allow for the transfer (e.g., uploading or downloading) of data, such as machine learning model training data.

In some embodiments, the communication port(s) 209 are configured to couple the MLE 102 to a network. The network can include local area networks (LAN) as well as wide area networks (WAN) including without limitation Internet, wired channels, wireless channels, communication devices including telephones, computers, wire, radio, optical and/or other electromagnetic channels, and combinations thereof, including other devices and/or components capable of/associated with communicating data. For example, the communication environments can include in-body communications, various devices, and various modes of communications such as wireless communications, wired communications, and combinations of the same.

In some embodiments, the transceiver 204 and/or the communication port(s) 209 are configured to utilize one or more communication protocols. Examples of wired protocols can include, but are not limited to, Universal Serial Bus (USB) communication, RS-232, RS-422, RS-423, RS-485 serial protocols, Fire Wire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, etc. Examples of wireless protocols can include, but are not limited to, the Institute of Electrical and Electronics Engineers (IEEE) 802.xx series of protocols, such as IEEE 802.11a/b/g/n/ac/ag/ax/be, IEEE 802.16, IEEE 802.20, GSM cellular radiotelephone system protocols with GPRS, CDMA cellular radiotelephone communication systems with 1×RTT, EDGE systems, EV-DO systems, EV-DV systems, HSDPA systems, Wi-Fi Legacy, Wi-Fi 1/2/3/4/5/6/6E, wireless personal area network (PAN) protocols, Bluetooth Specification versions 5.0, 6, 7, legacy Bluetooth protocols, passive or active radio-frequency identification (RFID) protocols, Ultra-Wide Band (UWB), Digital Office (DO), Digital Home, Trusted Platform Module (TPM), ZigBee, etc.

The display 206 can be any suitable display, and may display the user interface 205. For example, the user interfaces 205 can enable user interaction with the MLE 102 and/or the web server 104. In some embodiments, a user can interact with the user interface 205 by engaging the input-output devices 203. In some embodiments, the display 206 can be a touchscreen, where the user interface 205 is displayed on the touchscreen.

The display 206 can include a screen such as, for example, a Liquid Crystal Display (LCD) screen, a light-emitting diode (LED) screen, an organic LED (OLED) screen, a movable display, a projection, etc. In some embodiments, the display 206 can include a coder/decoder, also known as Codecs, to convert digital media data into analog signals. For example, the visual peripheral output device can include video Codecs, audio Codecs, or any other suitable type of Codec.

The optional location device 211 may be communicatively coupled to a location network and operable to receive position data from the location network. For example, in some embodiments, the location device 211 includes a GPS device configured to receive position data identifying a latitude and longitude from one or more satellites of a GPS constellation. As another example, in some embodiments, the location device 211 is a cellular device configured to receive location data from one or more localized cellular towers. Based on the position data, the MLE 102 may determine a local geographical area (e.g., town, city, state, etc.) of its position.

In some embodiments, the MLE 102 is configured to implement one or more modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software.

In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the embodiments herein.

The network environment 100 further includes one or more machine model training systems that are communicatively coupled with at least one or more machine model database maintaining trained models and one or more training data databases (e.g., database 116) that stores relevant training data to train and/or retrain the one or more machine models used by the MLE 102. The machine model training system includes one or more machine model training servers or managers, which are implemented through one or more computing systems, servers, computers, processor and/or other such systems communicatively coupled with one or more of the distributed communication networks 118, and are configured to build and/or train the machine learning models. In some implementations, the model training system includes multiple sub-model training systems each associated with one or more of the different machine learning models.

The training data database stores and updates relevant training data. The training data may include historical data of previously loaded models. The historical data may include the run time of loading the models, the size of the models, the occurrence of the models (e.g., time of loading the models), the frequency of loading the models, etc. Further, the training data may include historic data, typically for one or more years. Further, the training system is configured to receive feedback information at least through the graphical user interface. This feedback can include changes in settings, requests for other information, clicks to other information, clicks to more detailed information, tagging of information for another potential recipient, indications of like and/or dislike of information, comments, actions indicating a disregard of types of information, searches performed, subsequent use of information provided, subsequent actions taken by recipients following access to different information, and other such feedback. The training system utilizes the feedback information to repeatedly over time retrain the machine models to repeatedly provide over time retrained machine models to provide more accurate outputs. This allows the machine models to be refined to provide accurate generated outputs.

The training data databases (e.g., database 116) can be local to the machine model training system, remote and accessible over one or more of the communication networks 118 or a combination of local and distributed. The machine model training system uses the relevant machine learning data to train the machine learning machine models. In some embodiments, one or more training processes are similar to the process performed by one or more machine models after having been trained, but can be trained with multiple sets of training data (e.g., some real and some simulated or synthetic for training). Predictions are compared to actuals to ensure that the set of machine models are operating with a certain threshold confidence. Further, the machine model training system is configured to receive feedback information through the graphical user interface corresponding to actions by the recipient interfacing with the graphical user interface.

The above and below description includes descriptions of embodiments implementing and/or utilizing trained machine learning models and/or neural networks. For example, the systems and methods described herein may utilize one or more natural language processing (NLP) machine models to process spoken language. In some embodiments, the neural network, machine learning models and/or machine learning algorithms may include, but are not limited to, Large Language models (LLM), Heuristics, Univariate based techniques, Multivariate, control limit, isolation forest and LOF-ensembles, deep learning machine models such as LSTM-based autoencoders, variational autoencoders, deep stacking networks (DSN), Tensor decp stacking networks, convolutional neural network, probabilistic neural network, autoencoder or Diabolo network, linear regression, support vector machine, Naïve Bayes, logistic regression, K-Nearest Neighbors (kNN), decision trees, random forest, gradient boosted decision trees (GBDT), K-Means Clustering, hierarchical clustering, DBSCAN clustering, principal component analysis (PCA), and/or other such machine models, networks and/or algorithms.

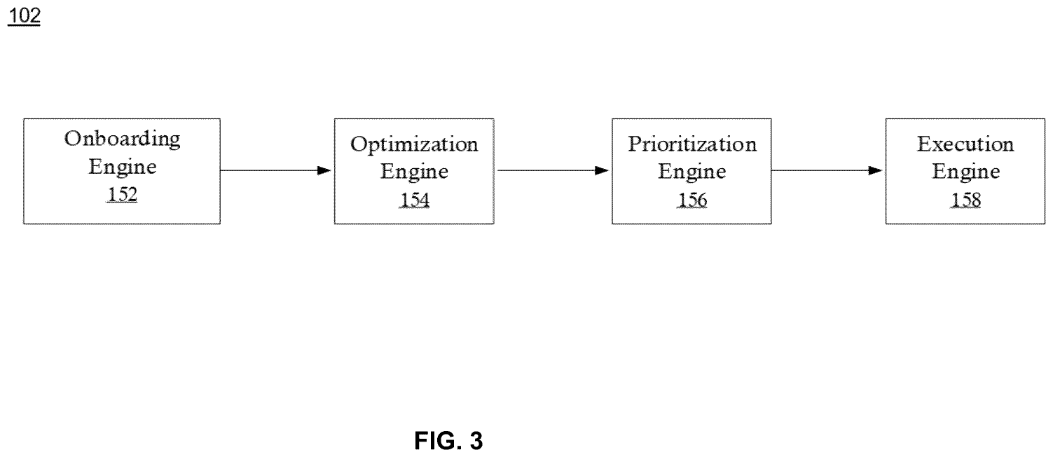

FIG. 3 is a block diagram of MLE 102, in accordance with some embodiments of the present teaching. As indicated in FIG. 3, MLE 102 may include onboarding engine 152, optimization engine 154, prioritization engine 156, and execution engine 158. Onboarding engine 152 may be configured to determine parameters associated with the planned model (e.g., the model to be loaded). For example, onboarding engine 152 may parse metadata associated with the model to determine the size, contents, creation date, source, target, and other parameters associated with the planned model. Onboarding engine 152 may transmit the model parameters to optimization engine 154. Based on the received model parameters, optimization engine 154 may generate a model score. Optimization engine 154 may compare the model score to a predetermined threshold. If the model score is greater than the predetermined threshold, than optimization engine 154 is configured to generate an optimization plan and implement the optimization plan. The optimization plan may include partitioning the model into a plurality of segments. In some embodiments, the plurality of segments are loaded in parallel. In other embodiments, the plurality of segments are loaded in series.

In some embodiments, optimization engine 154 utilizes one or more machine learning algorithms to generate an optimization plan. Optimization engine 154 may generate an optimization plan based on historical loading of previous models. In some embodiments, optimization engine 154 utilizes one or more models to identify future high priority models. The future high priority models may be models that need to be loaded immediately resulting in one or more segments of a planned model being placed on hold (e.g., waiting in the queue).

Upon partitioning the planned model into a plurality of segments, optimization engine 154 may transmit the plurality of segments to prioritization engine 156. Prioritizations engine 156 may be configured to prioritize one or more planned models based on their priority. For example, a second planned model may have a higher priority (e.g., due to criticality of its function) than a first planned model resulting in the first planned model being put into a queue while the second planned model is loaded. In some embodiments, prioritization engine 156 receives a plurality of segments associated with a plurality of planned models and ranks each segment based on their priority. Prioritization engine 156 may transmit the rankings (e.g., prioritization) of the plurality of segments for the plurality of planned models to execution engine 158. Execution engine 158 may be configured to execute the next segment based on the rankings from prioritization engine 156.

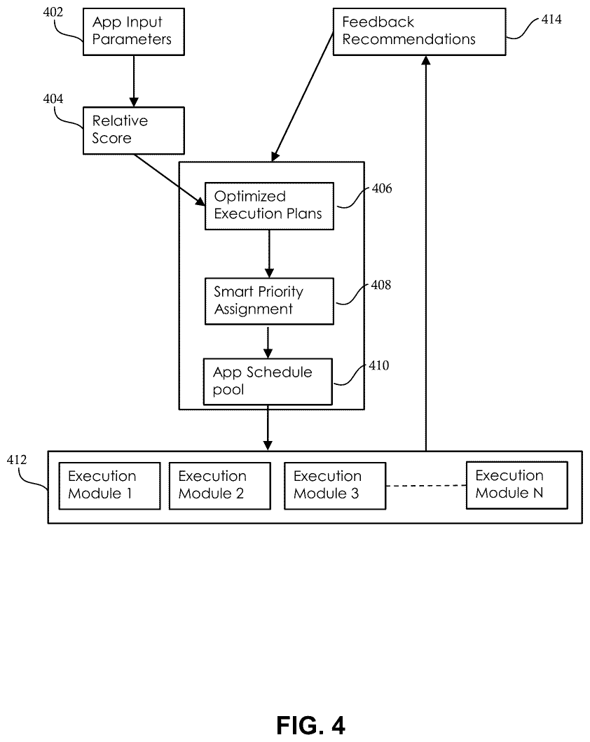

FIG. 4 illustrates an exemplary method of using MLE 102 and is detailed below with reference to FIG. 3.

At step 402, onboarding engine 152 receive a planned model to be loaded. Onboarding engine 152 may identify a plurality of model parameters associated with the planned model. The plurality of model parameters (e.g., input parameters) may include size of the planned model, run time of loading the planned model, source of the planned model, target of the planned model. In some embodiments, one or more model parameters have a higher weight (e.g., influence the score more) than other model parameters. For example, the file size of a planned model may have a higher weight than the date of creation of the planned model, and thus may impact the score more. In some embodiments, onboarding engine 152 uses one or more machine learning algorithms to process the plurality of model parameters and output a score. For example, each of the plurality of model parameters may be inputted into a machine learning algorithm, which outputs the score value for the planned model.

At step 404, MLE 102 may be configured to generate a score for a planned model. The score may be generate based on the plurality of model parameter. For example, using optimization engine 154, a score may be generated for each planned model based on the plurality of model parameters associated with each planned model. The generated score may be compared to a predetermined threshold value. In some embodiments, if the generated score of a planned model is outside (e.g., above) the predetermined threshold, then optimization engine 154 segments the planned model into a plurality of segments. If the generated score of a planned model is within the threshold (e.g., equal to or less than), then optimization engine 154 may proceed with loading the planned model as-is without segmenting the planned model into a plurality of segments.

At step 406, MLE 102 may be configured to generate an optimization plan for the planned model. The optimization plan may be based off of the generated score and may include how the planned model is partitioned into a plurality of segments. In some embodiments, the optimization plan includes loading the plurality of segments in parallel.

Optimization engine 154 may segment or partition the planned mode into a plurality of segments (e.g., based on the generated score). The plurality of segments may be substantially the same size. In some embodiments, one or more of the plurality of segments are different sizes. Optimization engine 154 may determine the segmentation the planned model based on the plurality of model parameters. For example, for a planned model having a large file size, optimization engine 154 may partition the planned model into more segments compared to when the planned model is a smaller size. In some embodiments, partitioning and loading of a planned model is herein referred to as distributed loading of the model (e.g., planned model).

In some embodiments, optimization engine 154 utilizes one or more machine learning algorithms to determine how to partition the planned model. Using historical data including previous models that have been loaded and/or partitioned, optimization engine 154 can determine the optimal partitioning of the planned model. For example, using one or more machine learning algorithms trained using historical data, optimization engine 154 may determine that large, high priority models are loaded on Fridays at midnight. Optimization engine 154 may receive a low or normal priority planned model for loading on a Friday and based on the high likelihood of a high priority model being loaded at midnight, optimization engine 154 may partition the planned model into a plurality of smaller segments and load them in parallel such that the model is loaded prior to midnight (e.g., prior to receiving a large, high priority model). Partition of the planned model allows for more efficient processing of large datasets by breaking them down into manageable portions. In some embodiments, optimization engine 154 utilizes distributed model loading techniques to enable MLE 102 to efficiently load and process models across multiple distributed resources, optimizing the overall execution speed and resource utilization.

At step 408, MLE 102 may be configured to prioritize the plurality of segments of the planned model. For example, based on the criticality of the planned model, the plurality of segments are assigned a priority and ranked among a plurality of segments of other planned models.

In some embodiments, prioritization engine 156 is configured to implement a priority-driven schedule pool to enqueue and dequeuc instances of loading of the planned model based on one or more prioritization parameters. The prioritization parameters may include a criticality component of how critical the planned model is.

At step 410, prioritization engine 156 may be configured to determine a schedule for loading one or more planned models based on the prioritization of each planned model and/or the priority of each partitioned segment of each model. This results in reduced development time, increased developer productivity, proper resource management of clusters. Prioritization engine 156 may utilizes a platform provides a smart run schedule pool to enqueue and dequeue the data loader application run instances based on priority and reduce latency in inference layer. Prioritization engine 156 may be configured to identify the best next job instance (e.g., next planned model). Prioritization engine 156 may consider various factors such as data availability, resource availability, and priority to determine the most suitable job to execute next. Prioritization engine 156 may be configured to rank and prioritize a plurality of planned jobs for loading. The plurality of planned jobs may include a plurality of segments of one or more planned models. Prioritization engine 156 may transmit the prioritization of the plurality of planned jobs to execution engine 158 for execution (e.g., loading) of the model. In some embodiments, prioritization engine 156 transmits each segment of a planned job to execution engine 158 based on the prioritization of each segment of each planned model. The priority assigned to each segment may be based on the criticality of the planned model the segment is associated with and/or the level of importance of the data. This ensures that critical data is processed in a timely manner and ahead of less critical data.

At step 412, execution engine 158 may receive a prioritization (e.g., ranking) of one or more segments from prioritization engine 156 for loading/executing. Execution engine 158 may be configured to identify the next highest priority job (e.g., best next job) for execution. Execution engine 158 may report the status of the planned model. For example, execution engine 158 may report that a portion of the planned model has been delivered for execution or that the full planned model has been executed and loaded. Execution engine 158 may be configured to execute the best next job based on the optimized plan generated by optimization engine 154 and the prioritization generated by prioritization engine 156. Execution engine 158 may dynamically scale up or down based on the resource utilization to ensure efficient processing.

Execution engine 158 may includes a plurality of execution modules configured to execute one or more planned models or segments of one or more planned models in parallel. This results in increased efficiency of loading modules, thereby reducing run times and latency. Execution engine 158 may be configured to generate logs (e.g., run logs) that include execution data associated with the execution of each segment and/or planned model. The execution data may include size of segment executed, run time of execution, source of segment, target of segment, number of segments associated with the planned model, time of execution, etc.

At step 414, MLE 102 is configured to parse the execution data of the run logs to generate resource allocation data. The resource allocation data may be used by one or more machine learning algorithms to determine how to partition and/or prioritize one or more planned models. MLE 102 may refine one or more optimization plans and prioritization plans based on the execution data. In some embodiments, MLE 102 parses the execution data and refines one or more machine learning algorithms utilized by one or more components of MLE 102 (e.g., optimization engine 154, prioritization engine 156). MLE 102 may be configured to generate feedback recommendations to implementing by one or more of optimization engine 154 and prioritization engine 156.

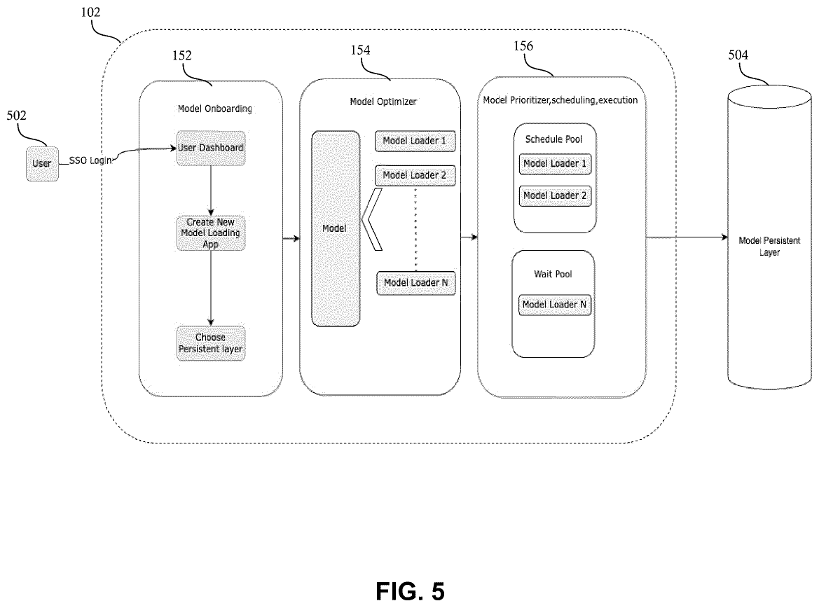

FIG. 5 illustrates a system architecture of MLE 102. As illustrated in FIG. 5 and discussed above, MLE 102 includes onboarding engine 152. Onboarding engine 152 may be configured to receive user session data associated with user 502. Onboarding engine 152 may authenticate user 502. User 502 may utilize a user dashboard of onboarding engine 152 to create a new model loading application for loading a planned model. Upon creation of the planned model, user 502 may choose a persistent layer of loading of the model. Onboarding engine 152 may transmit the planned model to optimization engine 154.

Optimization engine 154 may be configured to break or partition the planned model generated by onboarding engine 152 by the user into a plurality of segments (e.g., model loader 1, model loader 2, model loader N). Optimization engine 154 may transmit the plurality of segments to prioritization engine 156. Prioritization engine 156 may be configured to prioritize and rank the plurality of segments. For example, prioritization engine 156 may pool a first set of segments into a schedule pool and a second set of segments into a wait pool. The schedule pool may include one or more segments to be loaded and the wait pool may include one or more segments that are in queue. The wait pool may include one or more segments of one or more planned models that have a lower priority compared to the one or more segments in the schedule pool.

In some embodiments, the one or more segments are loaded into model persistent layer 504. For example, one or more segments may be executed via execution engine 158 and loaded into persistent layer 504 based on their priority (e.g., schedule pool or wait pool).

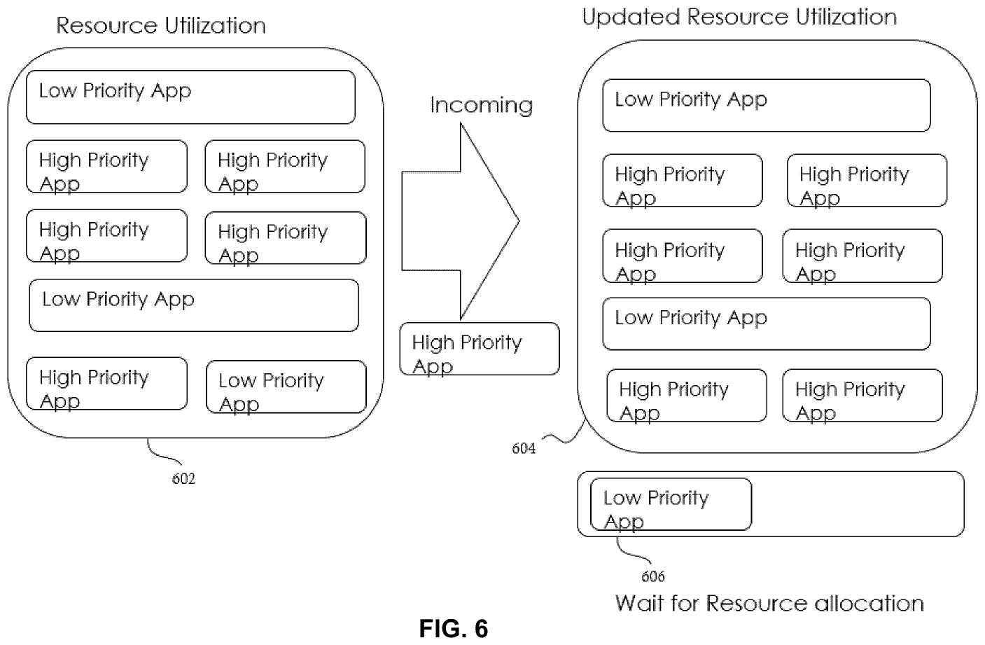

FIG. 6 is an illustration of a plurality of models or applications in a queue to be loaded. Set 602 may include a plurality of applications to be loaded and/or executed via execution engine 158. Each applications (e.g., model) within set 602 is tagged with a priority. For example, each application is tagged as either low priority or high priority. As shown in FIG. 6, a new high priority application is received resulting in set 604 including the high priority application and pushing a low priority application to waiting set 606. Waiting set 606 may be a queue that includes low priority applications. The low priority segments of waiting set 606 may be executed once resources are available. For example, resources may be allocated to loading and executing a plurality of applications within set 604. Upon completion of one or more applications being loaded from set 604, one or more applications may be transferred from set 606 to set 604 for loading.

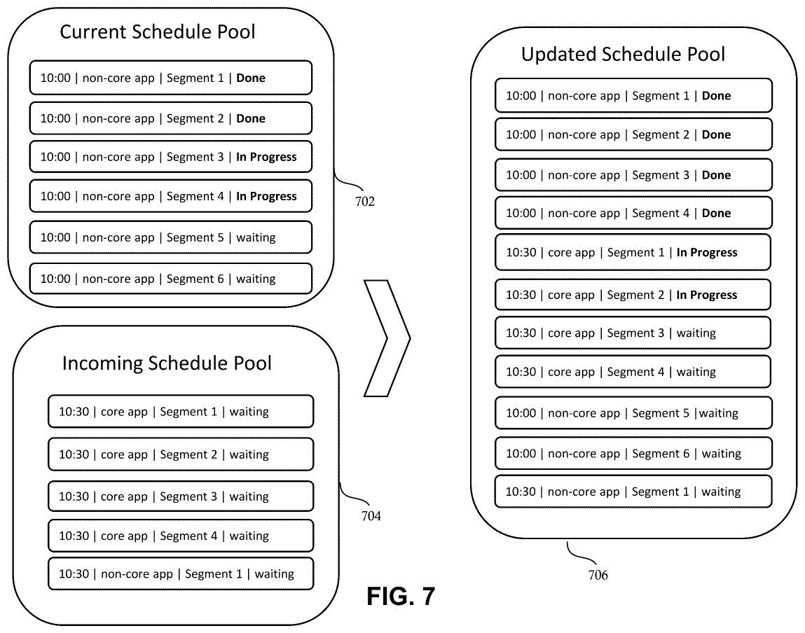

FIG. 7 illustrates a prioritization of a plurality of segments via prioritization engine 156. In some embodiments, pool 702 is a current schedule pool includes a set of segments currently being loaded sequentially and pool 704 is an incoming schedule pool. In some embodiments, incoming segments of pool 702 are to be combined with the pool 702 to form pool 706 (e.g., execution pool) to create a pool of all the segments of pool 702 and pool 704. Pool 702 may include a plurality of segments that have been loaded (e.g., tagged as “Done”). Pool 702 may also include a plurality of segments that are in progress of being loaded and a plurality of segments that are in queue to be loaded (e.g., tagged as “waiting”). Since pool 704 includes segments that are incoming, each segment of pool 704 is tagged as “waiting” as they are currently not being loaded.

Traditionally, the segments within pool 704 would be added to the end of the list of segments in pool 702 resulting in all the segments of pool 702 being loaded first prior to any segment of pool 704 being loaded. However, using the systems and methods described herein, pool 704 may be combined with pool 702 such that higher priority segments are loaded first prior to lower priority segments.

As illustrated in FIG. 7, pool 702 includes six segments each associated with a non-core application. In other words, each segment of pool 702 is low priority as they are associated with non-core applications. Pool 704 includes a five segments, where four segments are associated with a core application and one segments is associated with a non-core application. Using prioritization engine 156, pool 704 may be combined with pool 702 to generate pool 706. Pool 706 may include segments that have already been loaded (e.g., from pool 702), segments that are currently being loaded (e.g., from pool 702), and segments in queue to be loaded (e.g., from pool 702 and pool 704). The prioritization of the segments to be loaded within pool 704 are such that the higher priority segments (e.g., associated with core applications) are to be loaded prior to lower priority segments (e.g., associated with non-core applications) This ensures that resources are allocated efficiently and based on criticality of the models to be loaded rather than sequentially (e.g., first-come, first-served).

In some embodiments, MLE 102 is configured to pause a lower priority segment when a higher priority segment is received. For example, MLE 102 may be in the process of loading a low priority segment due to there being enough resources allocated to load the low priority segment. During loading of the low priority segment, a high priority segment may be received. MLE 102 may be configured to pause loading of the low priority segment to load the high priority segment. Upon completion of the high priority segment, MLE 102 may resume loading the low priority segment. In some embodiments, high priority segments take precedence over scheduled low priority segments resulting in the low priority segment being dequeued and/or pushed further down the queue.

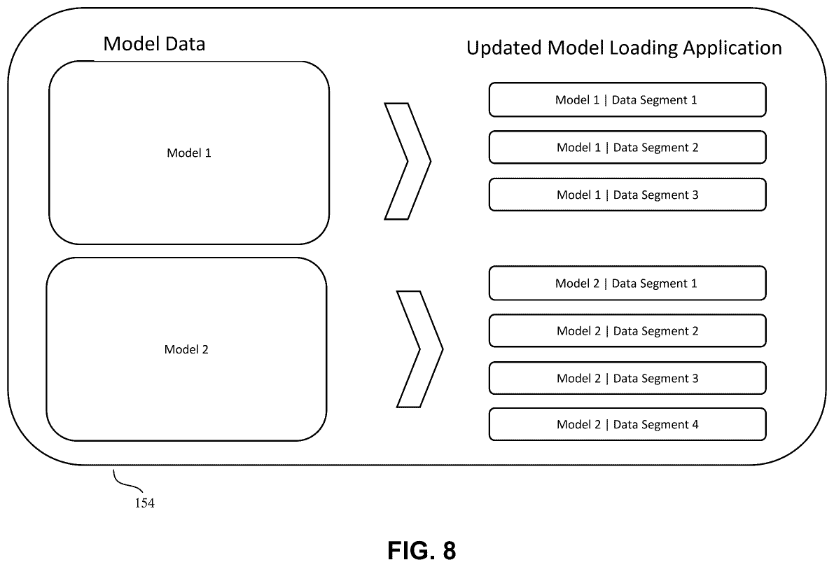

FIG. 8 illustrates partitioning of two models via optimization engine 154. As shown in FIG. 8 optimization engine 154 may be configured to partition one or more planned models (e.g., model 1, model 2) into a plurality of segments or chunks. For example, optimization engine 154 may partition model 1 into a three segments and partition model 2 into four segments. In some embodiments, model 2 is larger in size than model 1 and thus requires a greater number of segments. In some embodiments, the segments are not required to be loaded in sequential order. For example, model 1 may be partitioned into data segment 1, data segment 2, and data segment 3. Data segment 1 and data segment 2 may be substantially the same file size and data segment 3 may be less than data segment 1 and data segment 2. Based on resource allocations, MLE 102 may be configured to load data segment 3 prior to loading data segment 1 and/or data segment 2.

In some embodiments, MLE 102 is scalable to accommodate a large number of models and a large number of segments. MLE 102 may be configured to utilize distributed model loading techniques to enhance data processing capacity and improve processing times. In some embodiments, MLE 102 is configured to identify one or more parameters and generate a score based on the one or more parameters. MLE 102 may be configured to partition or split large data sets into smaller chunks for optimized execution plans. MLE 102 may be configured to assign priority to one or more segments according to the business criticality and identify the next optimal job for loading.

In some embodiments, MLE 102 is configured to utilize previously loaded of models to determine loading of planned models. For example, MLE 102 may generate execution data based on executed and loaded models. MLE 102 may refine the optimization and prioritization of one or more segments based on the execution data.

In some embodiments, MLE 102 utilizes one or more CPUs and/or GPUs. MLE 102 may utilize one or more GPUs and/or CPUs to execute high-priority model segments in parallel, thereby optimizing loading efficiency. In some embodiments, MLE 102 is configured to enhance loading speed and real-time responsiveness by leveraging GPU and/or CPU acceleration. MLE 102 may be configured to efficiently allocate GPU and/or CPU resources based on the priority of model segments and historical execution patterns. In some embodiments, MLE 102 is configured to dynamically scale GPU and/or CPU usage to meet varying workload demands, ensuring adaptive resource allocation.

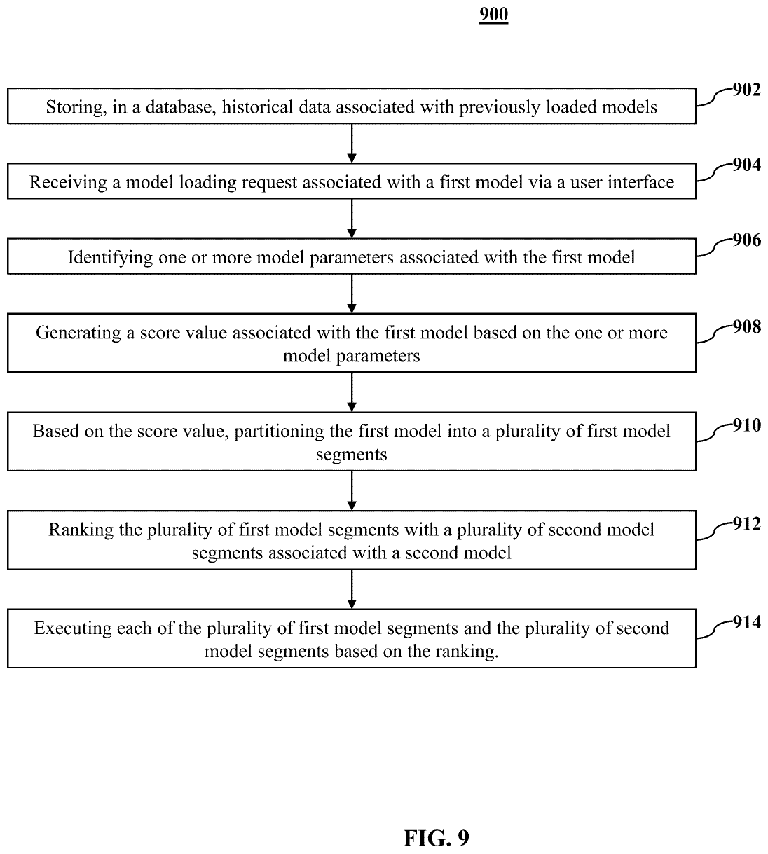

FIG. 9 is a flowchart illustrating an exemplary method for dynamic distributed model loading. At operation 902, MLE 102 stores historical data within database 116. MLE 102 may receive historical data based on previously loaded or executed models. At operation 904, MLE 102 may receive a model loading request associated with a first model. MLE 102 may receive a model loading request from a user interface operated by a user. At operation 906, MLE 102 may be configured to identify one or more model parameters associated with the first model. The one or more model parameters may include a source, a target, a run time, a creation date, contents, and other features associated with the first model. At operation 908, MLE 102 may be configured to generate a score value for the first model based on the one or more parameters. In some embodiments, MLE 102 may be configured to compare the score value to a predetermine threshold. If the score value is above a predetermine threshold, at operation 910, MLE 102 may be configured to partition the first model into a plurality of segments (e.g., first model segments).

At operation 912, MLE 102 may be configured to rank the plurality of segments along with a plurality of second model segments associated with a second model. For example, MLE 102 may be configured to rank the plurality of segments based on a criticality or priority of the segments. At operation 914, MLE 102 may execute each of the plurality of segments based on the ranking.

Although the methods described above are with reference to the illustrated flowcharts, it will be appreciated that many other ways of performing the acts associated with the methods can be used. For example, the order of some operations may be changed, and some of the operations described may be optional.

The methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Each functional component described herein can be implemented in computer hardware, in program code, and/or in one or more computing systems executing such program code as is known in the art. As discussed above with respect to FIG. 2, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 2.

The foregoing is provided for purposes of illustrating, explaining, and describing embodiments of these disclosures. Modifications and adaptations to these embodiments will be apparent to those skilled in the art and may be made without departing from the scope or spirit of these disclosures. Although the subject matter has been described in terms of exemplary embodiments, it is not limited thereto. Rather, the appended claims should be construed broadly, to include other variants and embodiments, which can be made by those skilled in the art.

What is claimed is:

1. A system, comprising:
a database storing historical data associated with previously loaded models;
a computing device comprising at least one processor in communication with the database, the computing device being configured to:
receive a model loading request associated with a first model via a user interface;
identify one or more model parameters associated with the first model;
generate a score value associated with the first model based on the one or more model parameters;
based on the score value, partition the first model into a plurality of first model segments;
rank the plurality of first model segments with a plurality of second model segments associated with a second model; and
execute each of the plurality of first model segments and the plurality of second model segments based on the ranking.

2. The system of claim 1, wherein the computing device is further configured to:
generate a status log based on the execution of the plurality of first model segments.

3. The system of claim 2, wherein the computing device is further configured to:
parse the status log to identify resource allocation data; and
using the resource allocation data, refine the execution of a subsequent model.

4. The system of claim 1, wherein the computing device is further configured to:
compare the score value to predetermined threshold; and
if the score value is above the predetermined threshold, partition the first model into the plurality of first model segments.

5. The system of claim 1, wherein the computing device is further configured to:
execute at least a subset of the plurality of first model segments in a parallel.

6. The system of claim 1, wherein each first model segment of the plurality of first model segments has a file size less than a file size of the first model.

7. The system of claim 1, wherein the ranking is based on a prioritization of the plurality of first model segments based on the one or more of the one or more model parameters and the historical data.

8. The system of claim 1, wherein the computing device is further configured to:
generate the score value using one or more machine learning algorithms; and
refine the one or more machine learning algorithms based on one or more of the historical data and the execution of the plurality of first model segments.

9. The system of claim 1, wherein one or more model parameters including one or more of file size, source, target, run time, creation date, and contents.

10. The system of claim 1, wherein the computing device is further configured to:
aggregate the plurality of first model segments with the plurality of second model segments to generate an execution pool;
receive a third model segment for execution, the third model segment having a higher priority than each of the plurality of first model segments and each of the plurality of second model segments;
rank the third model segment higher than each of the plurality of first model segments and each of the plurality of second model segment; and
execute the third model segment prior to each of the plurality of first model segments and each of the plurality of second model segments.

11. A method comprising:
storing, in a database, historical data associated with previously loaded models;
receiving a model loading request associated with a first model via a user interface;
identifying one or more model parameters associated with the first model;
generating a score value associated with the first model based on the one or more model parameters;
based on the score value, partitioning the first model into a plurality of first model segments;
ranking the plurality of first model segments with a plurality of second model segments associated with a second model; and
executing each of the plurality of first model segments and the plurality of second model segments based on the ranking.

12. The method of claim 11 further comprising:
generating a status log based on the execution of the plurality of first model segments.

13. The method of claim 12 further comprising:
parsing the status log to identify resource allocation data; and
using the resource allocation data, refine the execution of a subsequent model.

14. The method of claim 11 further comprising:
comparing the score value to predetermined threshold; and
if the score value is above the predetermined threshold, partition the first model into the plurality of first model segments.

15. The method of claim 11 further comprising:
executing at least a subset of the plurality of first model segments in a parallel.

16. The method of claim 11, wherein each first model segment of the plurality of first model segments has a file size less than a file size of the first model.

17. The method of claim 11, wherein the ranking is based on a prioritization of the plurality of first model segments based on the one or more of the one or more model parameters and the historical data.

18. The method of claim 11 further comprising:
generating the score value using one or more machine learning algorithms; and
refining the one or more machine learning algorithms based on one or more of the historical data and the execution of the plurality of first model segments.

19. The method of claim 11 further comprising:
aggregating the plurality of first model segments with the plurality of second model segments to generate an execution pool;
receiving a third model segment for execution, the third model segment having a higher priority than each of the plurality of first model segments and each of the plurality of second model segments;
ranking the third model segment higher than each of the plurality of first model segments and each of the plurality of second model segment; and
executing the third model segment prior to each of the plurality of first model segments and each of the plurality of second model segments.

20. A non-transitory computer readable medium having instructions stored thereon, wherein the instructions, when executed by at least one processor, cause at least one device to perform operations comprising:
storing, in a database, historical data associated with previously loaded models;
receiving a model loading request associated with a first model via a user interface;
identifying one or more model parameters associated with the first model;
generating a score value associated with the first model based on the one or more model parameters;
based on the score value, partitioning the first model into a plurality of first model segments;
ranking the plurality of first model segments with a plurality of second model segments associated with a second model; and
executing each of the plurality of first model segments and the plurality of second model segments based on the ranking.
